(19) United States
(12) Patent Application Publication
(10) Pub. No.: US 2026/0138684 A1
(43) Pub. Date: May 21, 2026

(54) HYBRID METAL COMPOSITE UNDERBODY FLOOR ASSEMBLY FOR A VEHICLE

(71) Applicant: GM Global Technology Operations LLC, Detroit, MI (US)

(72) Inventors: Venkateshwar R. Aitharaju, Troy, MI (US); Bradley Allen Newcomb, Troy, MI (US); Selina Xinyue Zhao, Rochester Hills, MI (US); Xiaosong Huang, Novi, MI (US); Bhavesh Shah, Troy, MI (US); Manoj Marella, Bengaluru (IN); Amitabh Kumar, Bengaluru (IN)

(73) Assignee: GM Global Technology Operations LLC, Detroit, MI (US)

(21) Appl. No.: 18/951,463

(22) Filed: Nov. 18, 2024

(51) Int. Cl. B62D 29/00; B32B 3/08; B32B 3/30; B32B 15/08; B62D 25/20; B62D 27/02

(52) U.S. Cl. CPC B62D 29/004; B32B 3/085; B32B 3/30; B32B 15/08; B62D 25/20; B62D 27/023; B32B 2250/02; B32B 2605/00

(57) ABSTRACT

A method of manufacturing a vehicular underbody floor assembly includes (i) overmolding a composite preform and one or more metallic sheets with an overmolded resin material to form a floor panel, the floor panel including a metallic portion and a composite portion, the metallic portion including a first flange extending along a first side of the floor panel and a second flange extending along a second side of the floor panel opposite the first side, and (ii) attaching a first end of a cross-rail to the first flange and a second end of the cross-rail to the second flange, the cross-rail including a metallic layer and a fiber layer, and the cross-rail extending between the first end and the second end and at least partially across the composite portion of the floor panel.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a floor assembly for a vehicle, and more particularly, to an underbody floor panel that extends along and over a battery assembly for a hybrid or electric vehicle. The floor assembly provides a surface beneath or at a lower portion of an interior cabin of a vehicle. The surface may be used for mounting seating assemblies and to generally separate the interior compartment from an underside of the vehicle and/or a battery assembly mounted beneath the cabin of the vehicle. In this regard, the floor assembly must be robust, durable, and strong to accommodate its many use cases. Further, the floor assembly must reasonably withstand potential deformation and damage during an impact, such as during a vehicle collision. That is, the floor assembly may resist buckling of a side rocker rail of the vehicle during a side impact. In many cases, such as if the vehicle is an electric vehicle (EV), a battery assembly is positioned at the underside of the vehicle. Preventing the floor assembly or side rocker rail from puncturing the battery assembly during a vehicle collision is another consideration.

Steel is a common material used in floor assemblies. However, the weight of steel may be excessive when applied at the floor assembly, as a significant amount of steel is generally required for the floor assembly to be robust, durable, and strong enough to withstand its various use cases. Based on the foregoing, and in an effort to reduce an overall weight of the vehicle, incorporating lightweight materials into a vehicle floor while simultaneously offering sufficient robustness, durability, and strength is desired.

### SUMMARY

One aspect of the disclosure provides a method of manufacturing a vehicular underbody floor assembly. The method includes (i) overmolding a composite preform and one or more metallic sheets with an overmolded resin material to form a floor panel, the floor panel including a metallic portion and a composite portion, the metallic portion including a first flange extending along a first side of the floor panel and a second flange extending along a second side of the floor panel opposite the first side, and (ii) attaching a first end of a cross-rail to the first flange and a second end of the cross-rail to the second flange, the cross-rail including a metallic layer and a fiber layer, and the cross-rail extending between the first end and the second end and at least partially across the composite portion of the floor panel.

Implementations of this aspect of the disclosure may include one or more of the following optional features. In some examples, the method further includes pretreating the one or more metallic sheets prior to overmolding.

In some implementations, the one or more metallic sheets are secured to the one or more metallic sheets prior to overmolding.

In some configurations, a seal is disposed at the one or more metallic sheets during overmolding to preclude the overmolded resin material from flowing onto a top portion of the one or more metallic sheets.

In some examples, a first metallic cap is disposed at the first end of the cross-rail and a second metallic cap is disposed at the second end of the cross-rail. Attaching the first end of the cross-rail to the first flange includes welding the first metallic cap to the first flange and wherein attaching the second end of the cross-rail to the second flange includes welding the second metallic cap to the second flange.

In some implementations, the metallic portion of the floor panel further includes an intermediate portion disposed between the first flange and the second flange. A middle portion of the cross-rail between the first end and the second end of the cross-rail is attached to the intermediate portion of the metallic portion.

In some configurations, the method further comprises pultruding the fiber layer onto the metallic layer to form the cross-rail. In some further configurations, the metallic layer is shaped prior to pultruding to form the cross-rail. In some even further configurations, the metallic layer and the fiber layer are shaped during pultruding to form the cross-rail.

In some examples, the composite preform includes a first portion having carbon fibers and a second portion having glass fibers, the second portion engaging the one or more metallic sheets.

Another aspect of the disclosure provides a vehicular underbody floor assembly. The vehicular underbody floor assembly includes a floor panel and a cross-rail. The floor panel includes a metallic portion and a composite portion. The metallic portion is joined to the composite portion by an overmolded resin material, the metallic portion including a first flange extending along a first side of the floor panel and a second flange extending along a second side of the floor panel opposite the first side. The cross-rail has a first end attached to the first flange and a second end attached to the second flange, the cross-rail including a metallic layer and a fiber layer, and the cross-rail extending between the first end and the second end and at least partially across the composite portion of the floor panel.

Implementations of this aspect of the disclosure may include one or more of the following optional features. In some examples, a first metallic cap is disposed at the first end of the cross-rail and welded to the first flange, and wherein a second metallic cap is disposed at the second end of the cross-rail and welded to the second flange.

In some implementations, the metallic portion of the floor panel further includes an intermediate portion disposed between the first flange and the second flange, and where a middle portion of the cross-rail between the first end and the second end of the cross-rail is attached to the intermediate portion of the metallic portion.

In some configurations, the metallic layer and the fiber layer are molded together via a pultruding process.

In some examples, the composite portion includes a first portion having carbon fibers and a second portion having glass fibers, the second portion joined to the metallic portion.

Yet another aspect of the disclosure provides a vehicle. The vehicle includes a battery assembly and an underbody floor assembly. The underbody floor assembly extends at least partially over the battery assembly. The underbody floor assembly includes a floor panel and a cross-rail. The floor panel includes a metallic portion and a composite portion. The metallic portion is joined to the composite portion by an overmolded resin material, the metallic portion including a first flange extending along a first side of the floor panel and a second flange extending along a second side of the floor panel opposite the first side. The cross-rail has a first end attached to the first flange and a second end attached to the second flange, the cross-rail including a metallic layer and a fiber layer, and the cross-rail extending between the first end and the second end and at least partially across the composite portion of the floor panel.

Implementations of this aspect of the disclosure may include one or more of the following optional features. In some examples, a first metallic cap is disposed at the first end of the cross-rail and welded to the first flange, and wherein a second metallic cap is disposed at the second end of the cross-rail and welded to the second flange.

In some implementations, the metallic portion of the floor panel further includes an intermediate portion disposed between the first flange and the second flange, and where a middle portion of the cross-rail between the first end and the second end of the cross-rail is attached to the intermediate portion of the metallic portion.

In some configurations, the metallic layer and the fiber layer are molded together via a pultruding process.

In some examples, the composite portion includes a first portion having carbon fibers and a second portion having glass fibers, the second portion joined to the metallic portion.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a vehicular underbody floor assembly according to the present disclosure;

FIG. 2 is a perspective view of the vehicular underbody floor assembly of FIG. 1;

FIG. 3 is a perspective view of a floor panel of the vehicular underbody floor assembly of FIG. 1;

FIG. 4 is a perspective view of a plurality of the cross-rails according to the present disclosure;

FIG. 5 is a perspective view of one of the plurality of cross-rails of FIG. 4;

FIG. 6 a sectional view of one of the plurality of cross-rails of FIG. 4 mounted at the floor panel,

FIG. 7 is a perspective view of a first flange extending along a first side of the floor panel of FIG. 3 and a rocker according to the present disclosure;

FIG. 8 is a plan view of a metallic sheet secured to a composite preform according to the present disclosure;

FIG. 9A is a plan view of a seal disposed at a surface of the metallic sheet secured to the composite preform of FIG. 8;

FIG. 9B is a sectional view of the metallic sheet secured to the composite preform of FIG. 8 within an overmolding tool according to the present disclosure;

FIG. 10 is a schematic diagram of a manufacturing process for a cross-rail according to the present disclosure; and

FIG. 11 is a flowchart of a method of manufacturing the vehicular underbody floor assembly of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

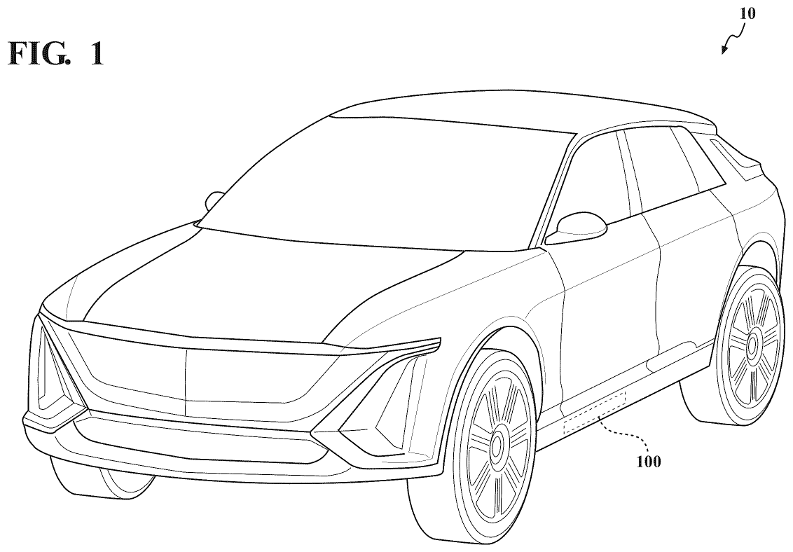

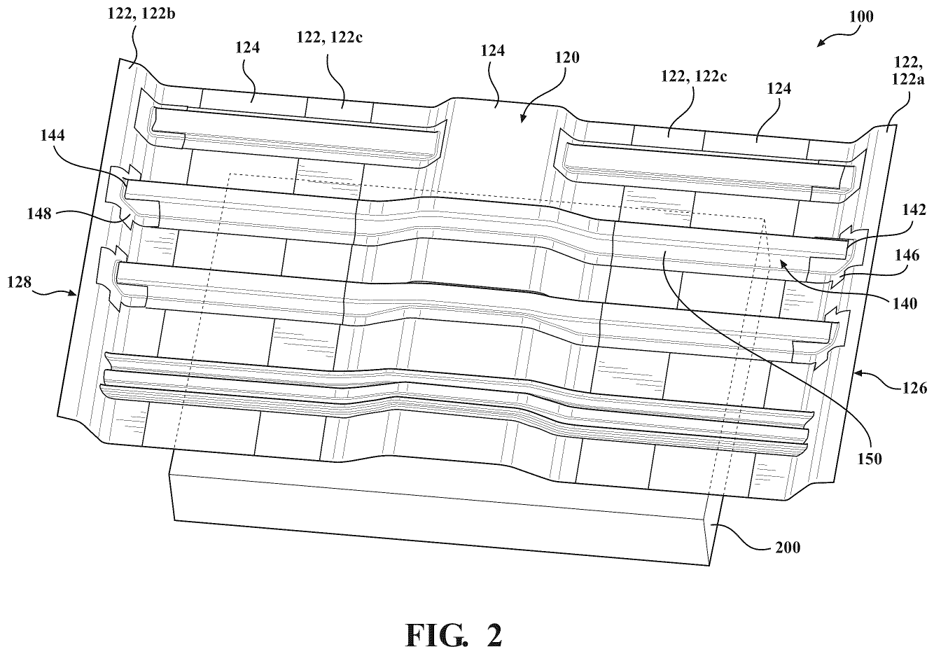

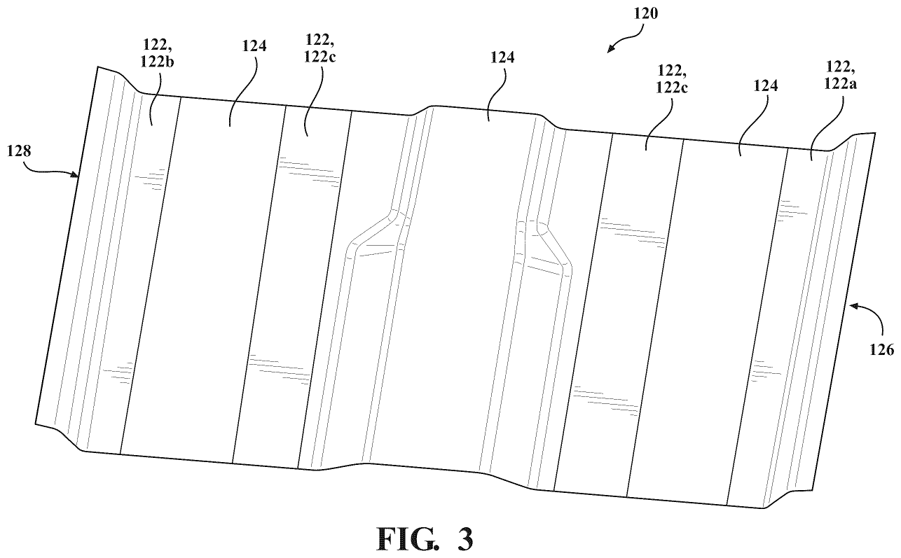

With reference to FIGS. 1-3, a vehicle 10 includes a vehicular underbody floor assembly 100. The vehicular underbody floor assembly 100 is configured to provide rigid structure to the vehicle 10 and provide a durable and strong surface for passengers or components within an interior compartment of the vehicle 10. For example, components supported by and/or mounted to the vehicular underbody floor assembly 100 may include seat assemblies, consoles, instrument panels, and the like. Further, the vehicular underbody floor assembly 100 separates the interior compartment from exterior of the vehicle 10. A battery assembly 200 may be positioned adjacent to the vehicular underbody floor assembly 100 at an underside of the vehicle 10. In this regard, the vehicular underbody floor assembly 100 retains the battery assembly 200 external of the interior compartment. Further, the vehicular underbody floor assembly 100 provides cross-body structural support for the vehicle 10, which may protect the integrity of the battery assembly 200 and resist buckling of the vehicle body and frame, such as during an impact at the vehicle 10 like a side vehicle collision.

The vehicular underbody floor assembly 100 includes a floor panel 120. The floor panel 120 includes one or more metallic portions 122 and one or more composite portions 124. As discussed further below, the metallic portions 122 and the composite portions 124 are joined together or integrally formed with one another to provide a unitary floor panel 120. In this regard, the floor panel 120 is a hybrid of both the one or more metallic portions 122 and the one or more composite portions 124. The one or more metallic portions 122 provide an interface for welding, mounting, etc. and also contributes to the strength, durability, and rigidity of the floor panel 120. The one or more metallic portions 122 may include steel, a steel alloy, aluminum or something of the like. The one or more composite portions 124 contribute to weight reduction of the floor panel 120 compared to if the floor panel 120 exclusively and solely included the one or more metallic portions 122. This is due to the one or more composite portions 124 including a lower density compared to a density of the one or more metallic portions 122. Further, the one or more composite portions 124 also contribute to the strength, durability, and rigidity of the floor panel 120. The illustrative examples show the floor panel 120 including four of the one or more metallic portions 122 and three of the one or more composite portions 124. However, it should be appreciated that the floor panel 120 may include less or more of the one or more metallic portions 122 and the one or more composite portions 124 without deviating from the context of this disclosure.

The floor panel 120 may have a shape or contour or profile that accommodates vehicle structure underneath the vehicle body (e.g., the battery assembly 200) and/or vehicle structure within the cabin of the vehicle 10. For example, the floor panel 120 may include a central raised portion that accommodates mounting of the battery assembly 200 underneath the vehicle 10. That is, the floor panel 120 may include minor ridges, protrusions, mounds, etc. that may vary based on the vehicle 10 at which the floor panel 120 is included and may vary based on the tooling used during manufacture of the floor panel 120. Further, the one or more metallic portions 122 include a first flange 122a and a second flange 122b. The first flange 122a extends along a first side 126 of the floor panel 120, and the second flange 122b extends along a second side 128 of the floor panel 120 opposite the first side 126. Both the first flange 122a and the second flange 122b protrudes away from the floor panel 120 in a manner that may be shaped to correspond to a rocker rail 300 included at the frame of the vehicle 10. In this regard, one rocker 300 at the vehicle 10 is configured to interface with the first flange 122a, and another rocker 300 at the vehicle 10 is configured to interface with the second flange 122b. The first flange 122a and the second flange 122b are enabled to be mounted, such as via welding or adhesive or mechanical fasteners, to respective inner portions 302 of each of the rockers 300 included at the vehicle 10, since the first flange 122a and the second flange 122b are metallic. Mounting the first flange 122a and the second flange 122b to respective inner portions 302 of each of the rockers 300 provides rigidity to the floor panel 120, and thus, provides rigidity to the vehicular underbody floor assembly 100. In other words, because the flanges 122a, 122b of the floor panel 120 are mounted to the respective rockers 300 of the vehicle 10, the floor panel 120 is able to accommodate load transfer from the rockers 300, such as during a side impact collision.

The one or more metallic portions 122 of the floor panel 120 also may include one or more intermediate portions 122c disposed between the first flange 122a and the second flange 122b. In the illustrated examples, the floor panel 120 includes two of the one or more intermediate portions 122c. However, it should be appreciated that the floor panel 120 may include more or less of the one or more intermediate portions 122c without deviating from the context of this disclosure. The one or more intermediate portions 122c provide a metallic interface for welding, joining, or otherwise attaching other components included at the vehicle 10 to the vehicular underbody floor assembly 100. In other words, welding is enabled at the one or more intermediate portions 122c due to its metallic makeup. Further, the intermediate portions 122c provide additional strength and durability to the vehicular underbody floor assembly 100.

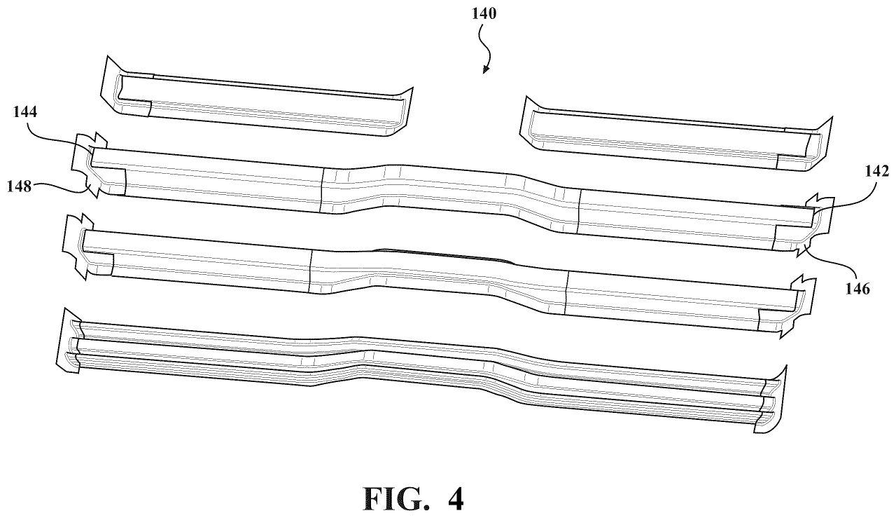

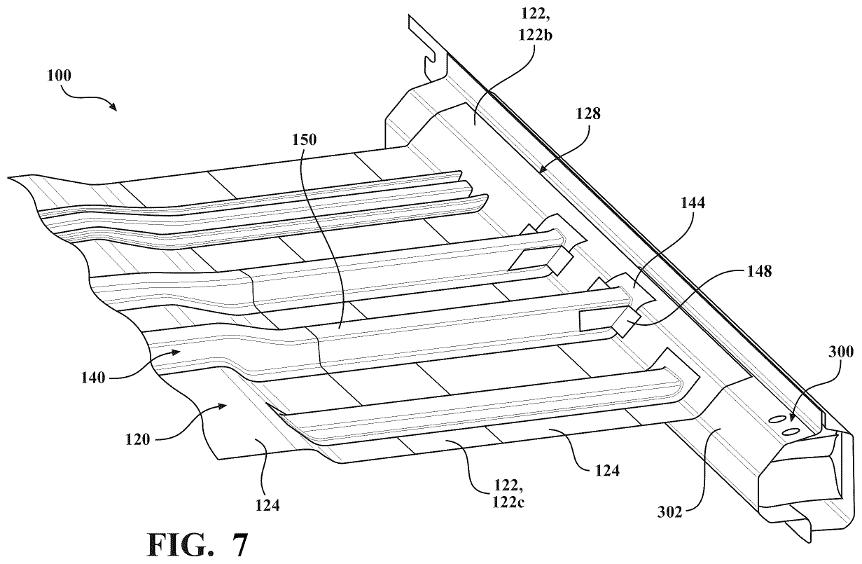

With continued reference to FIGS. 1-3, and with reference to FIGS. 4-7, the vehicular underbody floor assembly 100 also includes one or more cross-rails 140. Each of the one or more cross-rails 140 abut against an upper surface of the floor panel 120 and extend at least partially between the first side 126 of the floor panel 120 and the second side 128 of the floor panel 120. While the illustrated examples show four cross-rails 140 included at the vehicular underbody floor assembly 100, it should be appreciated that the vehicular underbody floor assembly 100 may include less or more of the one or more cross-rails 140 without deviating from the context of this disclosure. The one or more cross-rails 140 provide mechanical support and rigidity to the vehicular underbody floor assembly 100 and further protect the vehicular underbody floor assembly 100 from deformation during, for example, a side impact or vehicle collision. For example, side impact loads may be transferred through the rocker 300 and flange 122a, 122b and along one or more of the cross-rails 140 during a side impact. Further, the one or more cross-rails 140 includes a combination of metallic material and fiber material, such as glass fibers or carbon fibers, the details of which will be explained in greater detail below.

Each of the one or more cross-rails 140 may be continuous and unseparated between the first side 126 of the floor panel 120 and the second side 128 of the floor panel 120. Alternatively, each of the one or more cross-rails 140 may be separated and include two or more portions between the first side 126 of the floor panel 120 and the second side 128 of the floor panel 120. Regardless, each of the one or more cross-rails 140 extends across both the one or more metallic portions 122 and the one or more composite portions 124 of the floor panel 120. The one or more cross-rails 140 include a first end 142 and a second end 144 opposite the first end 142. The first end 142 is positioned at the first side 126 of the floor panel 120, and the second end 144 is positioned at the second side 128 of the floor panel 120. For example, the first end 142 and the second end 144 of the cross-rails 140 may be mounted to or attached (e.g., via welding or adhesive or mechanical fasteners) to one or both of the flanges 122a, 122b with a portion of the cross-rail 140 optionally mounted or attached to the intermediate portion 122c.

Included with each of the one or more cross-rails 140 is a first metallic cap 146 and a second metallic cap 148. The first metallic cap 146 is fixed to the first end 142 of each of the one or more cross-rails 140. The first metallic cap 146 is also fixed to the first flange 122a of the floor panel 120. In this regard, each of the one or more cross-rails 140 is fixedly attached to the floor panel 120 at the first flange 122a. Since the first flange 122a and the first metallic cap 146 are metallic, and the one or more cross-rails 140 are at least partially metallic, the first metallic cap 146 may be welded to the first end 142 of each of the one or more cross-rails 140. Further, the first metallic cap 146 is generally shaped to conform to a shape of the first flange 122a.

In a similar manner as described above, the second metallic cap 148 is fixed to the second end 144 of each of the one or more cross-rails 140. The second metallic cap 148 is also fixed to the second flange 122b of the floor panel 120. In this regard, each of the one or more cross-rails 140 is fixedly attached to the floor panel 120 at the second flange 122b. Since the second flange 122b and the second metallic cap 148 are metallic, and the one or more cross-rails 140 are partially metallic, the second metallic cap 148 may be welded to the second end 144 of each of the one or more cross-rails 140. Further, the second metallic cap 148 is generally shaped to conform to a shape of the second flange 122b.

The one or more cross-rails 140 also include a middle portion 150 that extends between the first end 142 and the second end 144. The middle portion 150 is attached at one or more attachment points 130 of the floor panel 120, such as via welding, adhering, bolting, or something of the like, to the one or more intermediate portions 122c of the floor panel 120. Attaching the middle portion 150 to the floor panel 120, the first metallic cap 146 at the first end 142 to the floor panel 120, and the second metallic cap 148 at the second end 144 to the floor panel 120, provides secure and unwavering rigid attachment of the one or more cross-rails 140 to the floor panel 120. This enhances the rigidity and overall strength and durability of the vehicular underbody floor assembly 100.

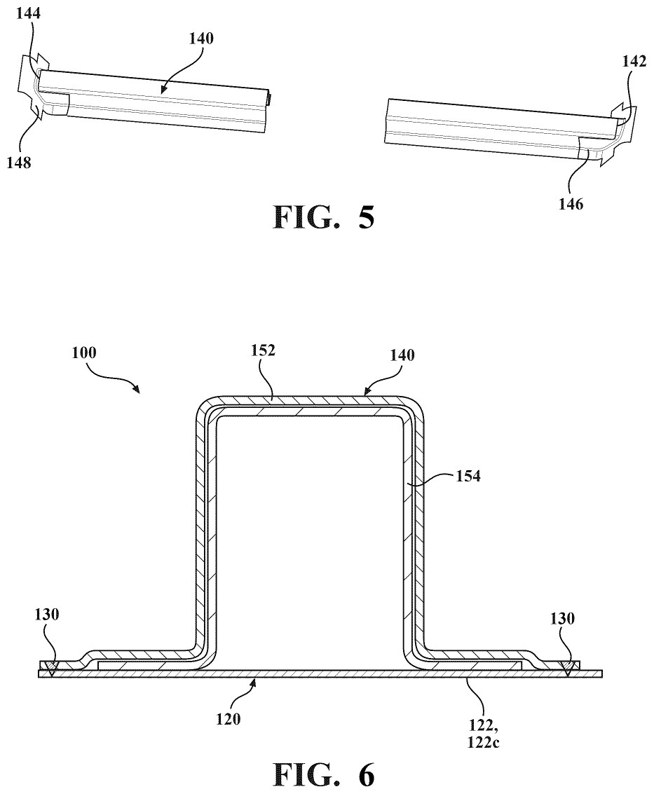

As shown in FIG. 5, the one or more cross-rails 140 may include a metallic layer 152 and a fiber layer or composite layer 154. The metallic layer 152 is external of the fiber layer 154 and interfaces with the floor panel 120 at the one or more attachment points 130. In other words, with the cross-rail 140 mounted to the floor panel 120, the fiber layer 154 is disposed between the metallic layer 152 and the floor panel 120, with a portion of the metallic layer 152 extending past the fiber layer 154 and along the floor panel 120 for attachment to the floor panel 120. In this regard, since the one or more intermediate portions 122c are included in the one or more metallic portions 122, the one or more cross-rails 140 may be welded to the one or more intermediate portions 122c of the floor panel 120. With the metallic layer 152 disposed at the exterior side of the cross-rail 140, vehicular components like seats may be mounted along the cross-rails 140. The fiber layer 154 may be fully concealed by the metallic layer 152 and the floor panel 120 when the one or more cross-rails are attached to the floor panel 120. Configuring the one or more cross-rails 140 with the metallic layer 152 and the fiber layer 154 provides sufficient durability and rigidity while simultaneously offering weight reduction for the vehicular underbody floor assembly 100.

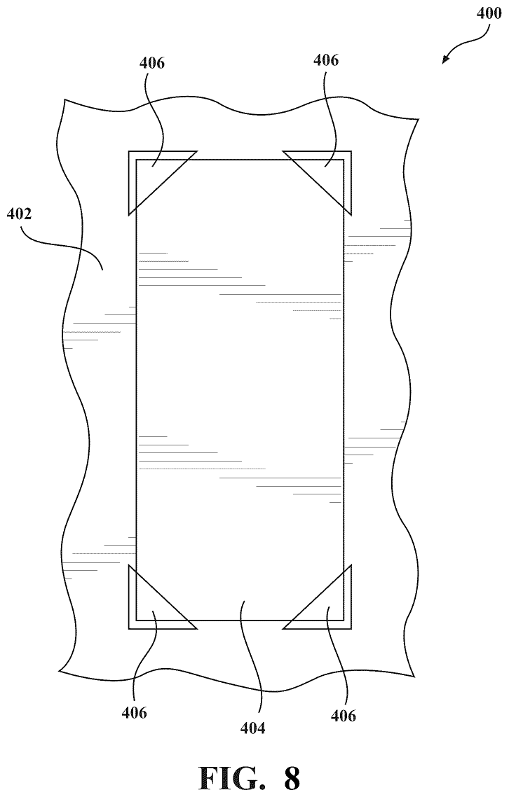

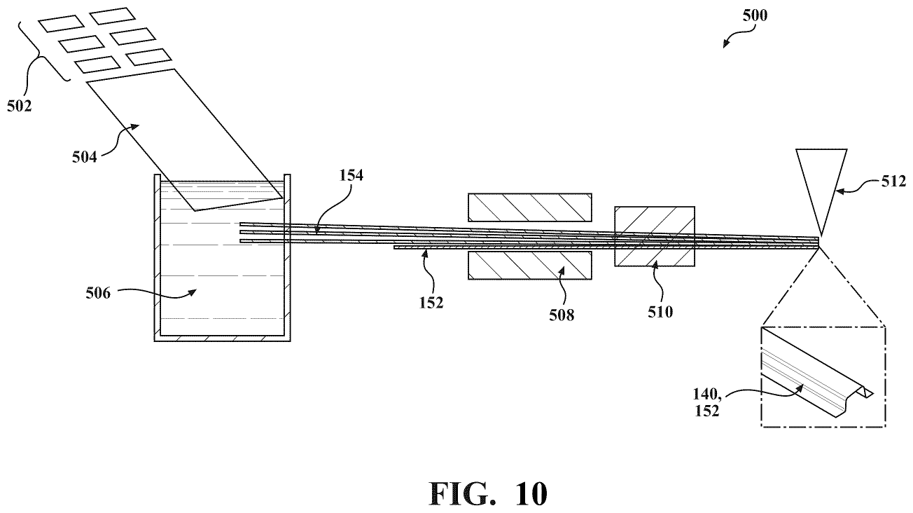

With reference to FIG. 8-10, a method 400 of manufacturing the floor panel 120 includes overmolding a composite preform 402 with one or more metallic sheets 404. The composite preform 402 may be of a uniform composite material. Alternatively, the composite preform 402 may include a first portion 402a having carbon fibers and a second portion 402b having glass fibers. The second portion 402b is configured to engage with the one or more metallic sheets 404 to prevent corrosion that may occur if the metallic sheet abuts carbon fibers. The metallic sheets 404 may be positioned at respective holes or recesses of the composite preform 402 and/or the metallic sheets 404 may be disposed at least partially along an upper surface of the composite preform 402. Further, the one or more metallic sheets 404 may be pre-treated before overmolding begins. Pre-treating may occur via laser ablation, plasma, or something of the like to enhance adhesion capabilities of the one or more metallic sheets 404 to a resin material and the composite preform 402 during overmolding.

The one or more metallic sheets 404 are secured to the composite preform 402 prior to overmolding (FIG. 8). Securement of the one or more metallic sheets 404 to the composite preform 402 prevents unwanted movement of the one or more metallic sheets 404 relative to the composite preform during overmolding. Securement of the one or more metallic sheets 404 may be accomplished in a variety of ways. For example, the one or more metallic sheets 404 may be tacked or otherwise adhered to the composite preform 402. In another example, the composite preform 402 may include a plurality of pockets 406 (e.g., formed from a fabric or polymer fiber material such as polyester or nylon stitches or the like) that are adhered to the composite preform 402. The one or more metallic sheets 404 are configured to fit into the plurality of pockets 406 and fix the one or more metallic sheets 404 relative to the composite preform 402.

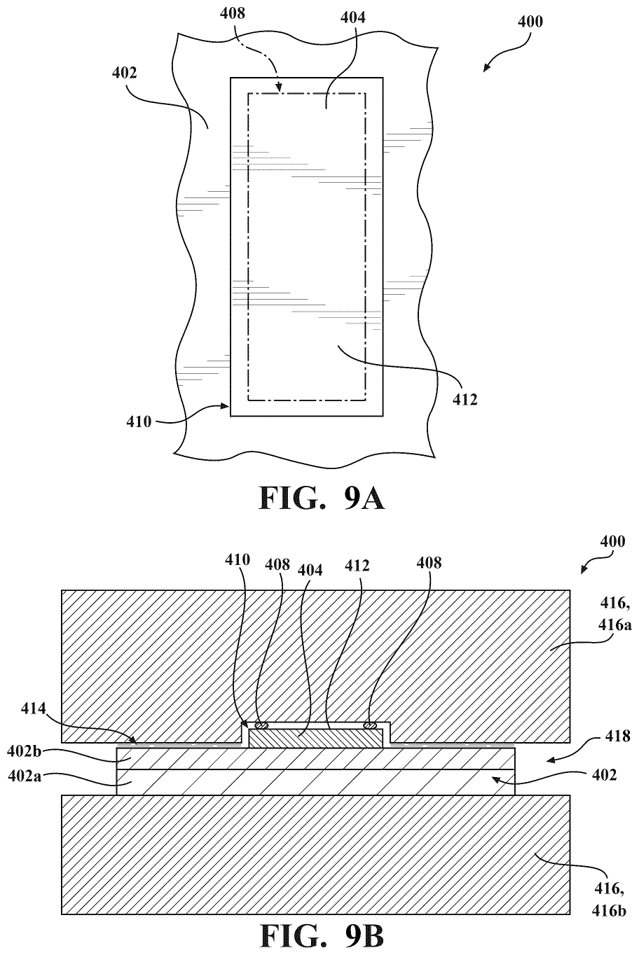

A seal 408 may be disposed at a surface of the one or more metallic sheets 404 prior to overmolding (FIG. 9A). The seal 408 is positioned at or near a perimeter 410 of the one or more metallic sheets 404 and is configured to seal and prevent a top portion 412 of the one or more metallic sheets 404 from contacting or interfacing with an overmolding resin material 414 during overmolding. In other words, the seal 408 precludes the overmolding resin material 414 from seeping onto the top portion 412 of the one or more metallic sheets 404 during overmolding. In this regard, the top portion 412 retains free of the overmolding resin material 414 so as to provide a metallic interface and enable welding. In other words, welding is prevented from occurring at portions of the one or more metallic sheets 404 that include the overmolding resin material 414. For example, the top portion 412 may ultimately be welded to a component at the vehicle 10 that interfaces with the one or more metallic sheets 404.

An overmolding tool 416 includes an upper tool 416a and a lower tool 416b (FIG. 9B). The composite preform 402, the one or more metallic sheets 404, and the seal 408 are positioned in a cavity 418 of the overmolding tool 416 between the upper tool 416a and the lower tool 416b. The overmolding resin material 414 is injected into the cavity 418 and overmolds the one or more metallic sheets 404 to the composite preform 402, thus forming the floor panel 120. That is, the overmolding resin material 414 may flow over and along the composite preform 402 and/or at least partially impregnate or saturate the composite preform 402 and the overmolding resin material 414 may flow over and along a portion of the metallic sheets 404 so that, upon cooling, the metallic sheets 404 are secured relative to the composite preform 402. The composite preform 402, the metallic sheets 404 and/or the cavity of the overmolding tool 416 may define the shape or contour of the floor panel 120.

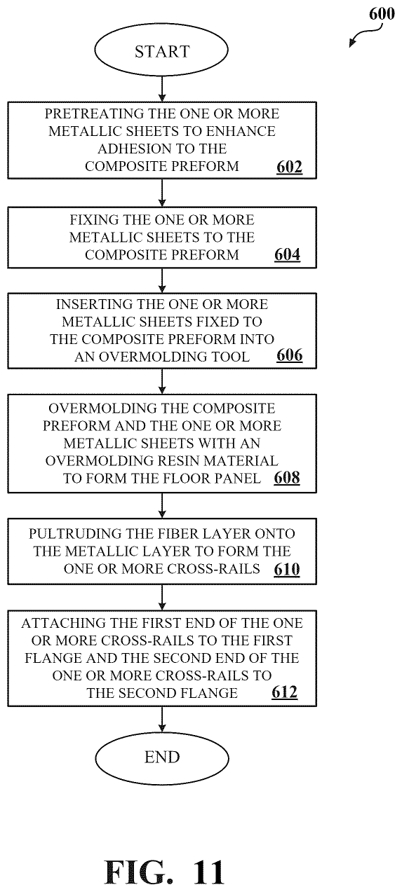

With reference to FIG. 11, a method 500 of manufacturing the one or more cross-rails 140 includes pultruding the fiber layer 154 onto the metallic layer 152 to form the one or more cross-rails 140. Prior to pultruding, dry fibers 502, such as composite fibers, and fabrics 504 are sent through a resin bath 506. The resin bath 506 forms the dry fibers 502 and the fabrics 504 into the fiber layer 154. The metallic layer 152 and the fiber layer 154 then passes through a heater 508. After the metallic layer 152 and the fiber layer 154 passes through the heater 508, pulling rods 510 pultrude the metallic layer 152 and the fiber layer 154 together to form the one or more cross-rails 140. In one example, the metallic layer 152 is shaped prior to pultruding at the pulling rods 510, such as via stamping. In another example, the metallic layer 152 and the fiber layer 154 are shaped simultaneously during the pultrusion process. For example, the metallic layer 152 and the fiber layer 154 may be stamped or roll-formed after the fiber layer 154 is pultruded onto the metallic layer 152. After pultruding, the one or more cross-rails 140 are then cut by a cutting tool 512 to configure and size the one or more cross-rails to fit at the floor panel 120.

With reference to FIG. 11, a method 600 of manufacturing the vehicular underbody floor assembly 100 includes, at operation 602, pretreating the one or more metallic sheets 404 to enhance adhesion to the composite preform 402. The one or more metallic sheets 404 is fixed to the composite preform 402 at operation 604. Fixing the one or more metallic sheets 404 to the composite preform 402 may occur via tacking or securing to the plurality of pockets 406. At operation 606, the one or more metallic sheets 404, fixed to the composite preform 402, are inserted into the cavity 418 of the overmolding tool 416. The overmolding resin material 414, at operation 608, is then injected into the cavity 418 of the overmolding tool 416, thus overmolding the one or more metallic sheets 404 to the composite preform 402, thus forming the floor panel 120. At operation 610, the one or more cross-rails 140 are formed via pultruding the fiber layer 154 onto the metallic layer 152. At operation 612, the first end 142 of the one or more cross-rails 140 are attached to the first flange 122a of the floor panel 120 via welding at the first metallic cap 146. In a similar manner, the second end 144 of the one or more cross-rails 140 are attached to the second flange 122b of the floor panel 120 via welding at the second metallic cap 148.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method of manufacturing a vehicular underbody floor assembly, the method comprising:
overmolding a composite preform and one or more metallic sheets with an overmolded resin material to form a floor panel, the floor panel including a metallic portion and a composite portion, the metallic portion including a first flange extending along a first side of the floor panel and a second flange extending along a second side of the floor panel opposite the first side; and
attaching a first end of a cross-rail to the first flange and a second end of the cross-rail to the second flange, the cross-rail including a metallic layer and a fiber layer, and the cross-rail extending between the first end and the second end and at least partially across the composite portion of the floor panel.

2. The method of claim 1, further comprising pretreating the one or more metallic sheets prior to overmolding.

3. The method of claim 1, wherein the one or more metallic sheets are secured to the one or more metallic sheets prior to overmolding.

4. The method of claim 1, wherein a seal is disposed at the one or more metallic sheets during overmolding to preclude the overmolded resin material from flowing onto a top portion of the one or more metallic sheets.

5. The method of claim 1, wherein a first metallic cap is disposed at the first end of the cross-rail and a second metallic cap is disposed at the second end of the cross-rail, and wherein attaching the first end of the cross-rail to the first flange includes welding the first metallic cap to the first flange and wherein attaching the second end of the cross-rail to the second flange includes welding the second metallic cap to the second flange.

6. The method of claim 1, wherein the metallic portion of the floor panel further includes an intermediate portion disposed between the first flange and the second flange, and where a middle portion of the cross-rail between the first end and the second end of the cross-rail is attached to the intermediate portion of the metallic portion.

7. The method of claim 1, further comprising pultruding the fiber layer onto the metallic layer to form the cross-rail.

8. The method of claim 7, wherein the metallic layer is shaped prior to pultruding to form the cross-rail.

9. The method of claim 7, wherein the metallic layer and the fiber layer are shaped during pultruding to form the cross-rail.

10. The method of claim 1, wherein the composite preform includes a first portion having carbon fibers and a second portion having glass fibers, the second portion engaging the one or more metallic sheets.

11. A vehicular underbody floor assembly comprising:
a floor panel including a metallic portion and a composite portion, the metallic portion joined to the composite portion by an overmolded resin material, the metallic portion including a first flange extending along a first side of the floor panel and a second flange extending along a second side of the floor panel opposite the first side; and
a cross-rail having a first end attached to the first flange and a second end attached to the second flange, the cross-rail including a metallic layer and a fiber layer, and the cross-rail extending between the first end and the second end and at least partially across the composite portion of the floor panel.

12. The vehicular underbody floor assembly of claim 11, wherein a first metallic cap is disposed at the first end of the cross-rail and welded to the first flange, and wherein a second metallic cap is disposed at the second end of the cross-rail and welded to the second flange.

13. The vehicular underbody floor assembly of claim 11, wherein the metallic portion of the floor panel further includes an intermediate portion disposed between the first flange and the second flange, and where a middle portion of the cross-rail between the first end and the second end of the cross-rail is attached to the intermediate portion of the metallic portion.

14. The vehicular underbody floor assembly of claim 11, wherein the metallic layer and the fiber layer are molded together via a pultruding process.

15. The vehicular underbody floor assembly of claim 11, wherein the composite portion includes a first portion having carbon fibers and a second portion having glass fibers, the second portion joined to the metallic portion.

16. A vehicle comprising:
a battery assembly; and
an underbody floor assembly extending at least partially over the battery assembly, the underbody floor assembly including:
a floor panel including a metallic portion and a composite portion, the metallic portion joined to the composite portion by an overmolded resin material, the metallic portion including a first flange extending along a first side of the floor panel and a second flange extending along a second side of the floor panel opposite the first side; and
a cross-rail having a first end attached to the first flange and a second end attached to the second flange, the cross-rail including a metallic layer and a fiber layer, and the cross-rail extending between the first end and the second end and at least partially across the composite portion of the floor panel.

17. The vehicle of claim 16, wherein a first metallic cap is disposed at the first end of the cross-rail and welded to the first flange, and wherein a second metallic cap is disposed at the second end of the cross-rail and welded to the second flange.

18. The vehicle of claim 16, wherein the metallic portion of the floor panel further includes an intermediate portion disposed between the first flange and the second flange, and where a middle portion of the cross-rail between the first end and the second end of the cross-rail is attached to the intermediate portion of the metallic portion.

19. The vehicle of claim 16, wherein the metallic layer and the fiber layer are molded together via a pultruding process.

20. The vehicle of claim 16, wherein the composite portion includes a first portion having carbon fibers and a second portion having glass fibers, the second portion joined to the metallic portion.
